(19) United States
(12) Patent Application Publication
(10) Pub. No.: US 2007/0296211 A1
(43) Pub. Date: Dec. 27, 2007

(54) Conductive pipe and pipe connector assembly thereof

(75) Inventor: Tsung-Cheng Huang, Taipei Hsien (TW)

Correspondence Address: BIRCH STEWART KOLASCH & BIRCH, PO BOX 747, FALLS CHURCH, VA, 22040-0747, US

(73) Assignee: COOLER MASTER CO., LTD.

(21) Appl. No.: 11/806,187

(22) Filed: May 30, 2007

(30) Foreign Application Priority Data
Jun. 22, 2006 (TW) 095210874

(51) Int. Cl. F16L 25/00

(52) U.S. Cl. 285/334.5

(57) ABSTRACT

A conductive pipe and a pipe connector assembly include a connection member, a coupling member and a hard conductive pipe which has at least one expanded portion at one end. The connection member is a tubular element and has at least one connecting portion which has a chamfered angle at one end to be tightly coupled with the expanded portion. The coupling member also is a tubular element and has at least a coupling portion to be coupled with the connecting portion and a chamfered surface in the tubular interior. When the connection member and the coupling member are coupled together, the expanded portion is tightly coupled with the chamfered angle. The pipe connector may be used on a liquid cooling apparatus and/or a liquid conveying pipe thereof to connect any two conductive pipes or connect the conductive pipe with a liquid cooling apparatus.

### FIELD OF THE INVENTION

The present invention relates to a conductive pipe and a pipe connector assembly thereof and particularly to a conductive pipe to connect two pipes that have an expanded portion at one end or to connect a conductive pipe with a liquid cooling apparatus and a pipe connector assembly thereof.

### BACKGROUND OF THE INVENTION

Electronic devices generate heat during operation that results in a higher temperature and a lower operation efficiency. There are many methods to lower the temperature. Using a thermal medium to perform heat exchange is one of them. The thermal medium may be gas or liquid. A complex cooling apparatus could use two types of thermal media. For instance use coolant (such as water or coolant) to perform heat exchange with electronic elements to absorb heat generated by the electronic elements, then use cooling air or air fans to dispel the heat absorbed by the coolant to the atmosphere.

Liquid has a better cooling effect (liquid cooling effect is 1.5 times of air cooling) and is quieter, and liquid cooling efficiency is better than air cooling. But liquid cooling apparatus also has drawbacks, such as installation and disassembly are more difficult, and the coolant has the leakage problem. With the advance of electronic element technology (such as faster clock time of CPU), the waste heat generated by computer elements increase greatly. Air cooling cannot meet heat dissipation requirement. As a result, liquid cooling apparatus for electronic equipment attract more attention again.

Liquid cooling apparatus tend to generate leakage problem at the coupling portion between the delivery pipe and the cooling unit or radiation unit. R.O.C. utility model publication No. 447736 discloses a technique which has a coupling sleeve connecting to a rubber hose. The rubber hose is prone to aging and deformation. As a result, coolant tends to leak out through the coupling sleeve and the rubber hose. And electronic elements could be short circuit and damaged. Moreover, the cooling unit or radiation unit often is connected to a pipe by soldering. Soldering increases fabrication process and results in a higher cost. Moreover, soldering also tends to cause flow back of soldering paste that could result in leaking of the coolant. This causes a great damage to electronic equipment.

### SUMMARY OF THE INVENTION

The primary object of the present invention is to provide a conductive pipe and a pipe connector assembly thereof to connect two hard pipes that have an expanded portion at one end or to connect a conductive pipe with an expanded portion at one end with a liquid cooling apparatus.

In an embodiment the invention includes a connection member, a coupling member and a hard conductive pipe which has at least one expanded portion at one end. The connection member has at least a connecting portion which has a chamfered angle at one end to be tightly coupled with the expanded portion. The coupling member has at least one coupling portion to be fastened to the connecting portion of the connection member. The coupling member has a chamfered surface inside the tube such that when the connection member and the coupling member are fastened together the expanded portion of the conductive pipe form a forced coupling with the chamfered angle so that the conductive pipe and the connecting portion of the connection member are tightly coupled together. Thereby coolant flowing in the conductive pipe does not leak out, and replacement and installation of the conductive pipe are easier.

Another object of the invention is to provide a pipe connector to connect two conductive pipes which have an expanded portion at one end. The pipe connector includes a connection member and two coupling members. The connection member has two ends to form a first connecting portion and a second connecting portion to be coupled respectively with two coupling members, thereby the two conductive pipes that have an expanded portion at one end can be connected respectively with the first and second connecting portions of the connection member, and the two conductive pipes can be connected with each other.

Yet another object of the invention is to provide a pipe connector to be used on a liquid cooling apparatus and a liquid conveying pipe to connect the coolant conveying pipe and the liquid cooling apparatus together. The pipe connector includes a connection member and a coupling member. The connection member has a connecting portion at one end and the other end fastened to the liquid cooling apparatus. Thereby a conductive pipe with an expanded portion at one end can be fastened to the connecting portion of the connection member, and the conductive pipe can be connected to the liquid cooling apparatus. As a result, the conductive pipe can be connected to the liquid cooling apparatus without soldering, and the leakage problem can be prevented.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of an embodiment of the invention.

FIG. 2 is a schematic view of an embodiment of the invention.

FIG. 3 is a sectional view according to FIG. 2.

FIG. 4 is a schematic view of the invention in a use condition.

FIG. 5 is an exploded view of another embodiment of the invention.

### DETAILED DESCRIPTION OF THE PREFERRED EMBODIMENTS

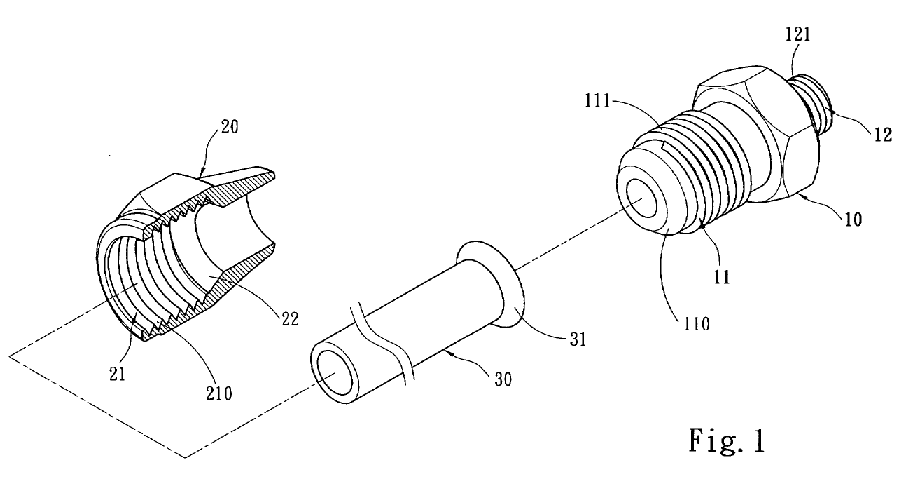

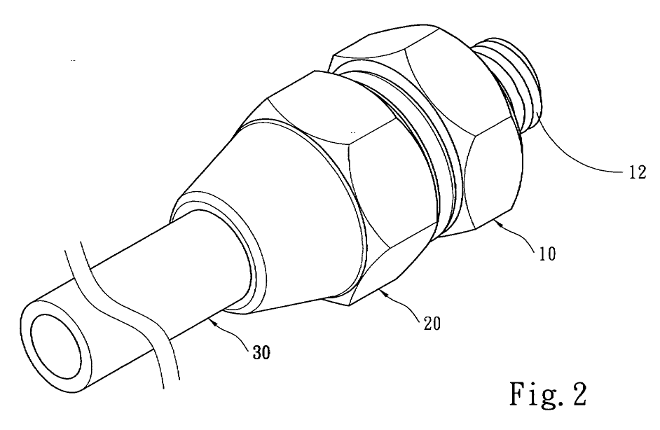

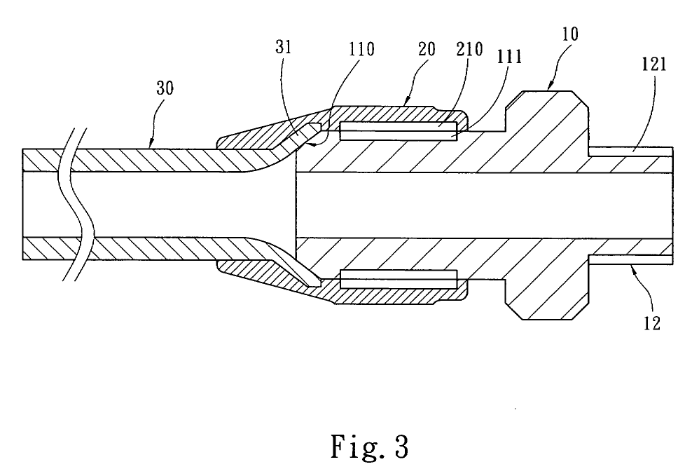

Please refer to FIGS. 1, 2 and 3, the invention includes a connection member 10, a coupling member 20 and a hard conductive pipe 30 which has at least an expanded portion 31 at one end.

The connection member 10 is a tubular element, and has at least a connecting portion 11 which has a chamfered angle 110 at one end to be tightly coupled with the expanded portion 31 of the conductive pipe 30. More specifically, the expanded portion 31 is substantially formed like a trumpet to couple with the chamfered angle 110 at one end of the connecting portion 11. The coupling member 20 also is a tubular element, and has at least one coupling portion 21 to be coupled with the connecting portion 11 of the connection member 10. The coupling member 20 has a chamfered surface 22 inside the tube. When the coupling member 20 and the connection member 10 are coupled together, the expanded portion 31 is forcefully fastened to the chamfered angle 110 of the connection member 10. Thus liquid or coolant can flow through the conductive pipe 30, coupling member 20 and connection member 10 without leaking.

In an embodiment of the invention, the connecting portion 11 of the connection member 10 has an external screw thread 111 formed on an outer surface, while the coupling portion 21 of the coupling member 20 has an internal screw thread 210 formed on an inner surface mating the external screw thread 111. Thereby the coupling member 20 and the connection member 10 can be fastened together. This also makes replacement and installation of the conductive pipe 30 easier. The conductive pipe 30 is preferably made of hard material, such as conductive metal (copper or aluminum) so that cooling effect can be enhanced when used on the liquid cooling apparatus. The hard conductive pipe 30 also can withstand a greater liquid pressure of the coolant.

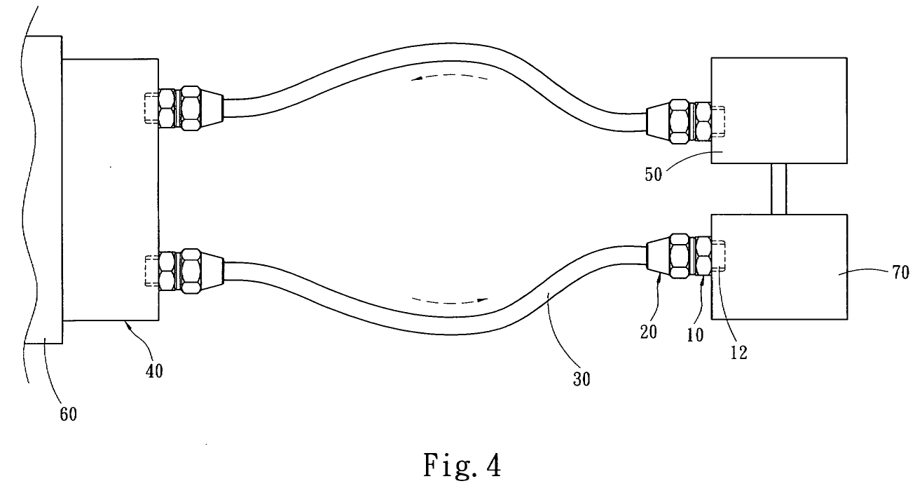

The connection member 10 has the other end forming a jutting fastening portion 12 which may be a pipe with an external screw thread 121 formed thereon to connect the conductive pipe 30 and the pipe connector assembly to a liquid cooling apparatus. Referring to FIG. 4, the liquid cooling apparatus is a water cooling apparatus, and includes a heat absorption unit 40 (such as a water cooling head) of a heat generation end 60 of an electronic element (such as CPU), a cooling unit 50 (such as a water cooler) to dispel heat and a pump 70. The heat absorption unit 40 has a heat exchange chamber (not shown in the drawings) to allow the cooling water and heat generation end 60 to perform heat exchange. The fastening portion 12 of the connection member is connected respectively to the heat absorption unit 40 and the cooling unit 50. The coolant is directed by the pump 70 to circulate between the heat absorption unit 40 and the cooling unit 50 to dispel heat. The pump 70 may also be located in the heat absorption unit 40 in an integrated fashion.

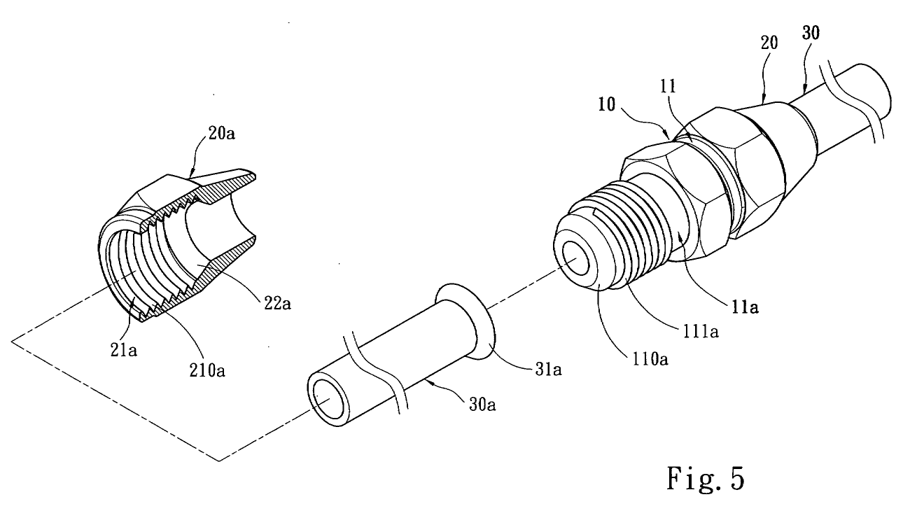

The fastening portion 12 at the other end of the connection member 10 shown in FIG. 1 may be changed to another connecting portion 11a. Namely two ends of the connection member 10 are formed in the same way as depicted in another embodiment shown in FIG. 5. The another connecting portion 11a also has a chamfered angle 110a to be tightly coupled with another expanded portion 31a at one end of another conductive pipe 30a. A second coupling member 20a also has an internal screw thread 210a to be screwed with an external screw thread 111a of a second connecting portion 11a. The second coupling portion 20a has the same structure as that of the coupling member 20, and has at least one coupling portion 21a to be fastened to the second connecting portion 11a. The second coupling member 20a also has a chamfered surface 22a. When the second coupling member 20a and the second connection member 11a are coupled together, the expanded portion 31a is fastened tightly to the chamfered angle 110a of the second connecting portion 11a. Thereby the two conductive pipes 30 and 30a can be connected together. When the liquid or coolant flows through the conductive pipes 30 and 30a, coupling members 20 and 20a, and connection member 10, no leakage occurs.

In short, the invention provides a connection member and a coupling member to connect a conductive pipe with a liquid cooling apparatus or connect two hard conductive pipes together without soldering. No soldering flow back takes place. It provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A pipe connector assembly, comprising:
a connection member which is a tubular element and has at least one connecting portion, wherein the connecting portion has a chamfered angle at one end thereof;
a conductive pipe having an expanded portion at one end thereof for tightly coupling with the chamfered angle of the connecting portion; and
a coupling member having at least one coupling portion coupled with the connecting portion of the connection member and a chamfered surface formed in a tubular interior thereof;
wherein the expanded portion is tightly coupled with the chamfered angle when the coupling member is coupled with the connecting portion.

2. The pipe connector assembly of claim 1, wherein the conductive pipe is a hard conductive pipe.

3. The pipe connector assembly of claim 1, wherein the conductive pipe is made of metal.

4. The pipe connector assembly of claim 3, wherein the conductive pipe is made of copper.

5. The pipe connector assembly of claim 3, wherein the conductive pipe is made of aluminum.

6. The pipe connector assembly of claim 1, wherein the connecting portion has an external screw thread formed on an outer surface thereof, and the coupling portion of the coupling member has an internal screw thread formed on an inner surface thereof and mated with the external screw thread.

7. The pipe connector assembly of claim 1, wherein the connection member has a jutting fastening portion formed at the other end thereof, and the jutting fastening portion is a tube with an external screw thread.

8. The pipe connector assembly of claim 1 further comprising:
a second connecting portion at the other end of the connection member, wherein the second connecting portion has a second chamfered angle at one end thereof;
a second conductive pipe having at least one second expanded portion at one end thereof, wherein the second expanded portion is tightly coupled with the second chamfered angle of the second connecting portion; and
a second coupling member having at least one second coupling portion coupled with the second connecting portion of the connection member and a second chamfered surface formed in a tubular interior thereof;
wherein the second expanded portion of the second conductive pipe is tightly coupled with the second chamfered angle when the second coupling member is coupled with the second connecting portion.

9. A liquid cooling apparatus installed in an electronic equipment to dissipate heat that is generated from a heat generation end of the electronic equipment, comprising a heat absorption unit located at the heat generation end and a cooling unit to dissipate heat, the heat absorption unit having a heat exchange chamber to allow a coolant to perform heat exchange with the heat generation end, the coolant being circulated through a conductive pipe and a pipe connector between the heat exchange chamber and the cooling unit; characterized in that:
the conductive pipe has at least one expanded portion at one end thereof, wherein the pipe connector includes:
a connection member which is a tubular element and has at least one connecting portion, wherein the connecting portion has a chamfered angle at one end thereof; and
a coupling member having at least one coupling portion to be coupled with the connecting portion of the connection member and a chamfered surface formed in a tubular interior thereof;
wherein the expanded portion is tightly coupled with the chamfered angle when the coupling member is coupled with the connecting portion.

10. The liquid cooling apparatus of claim 9, wherein the conductive pipe is a hard conductive pipe.

11. The liquid cooling apparatus of claim 9, wherein the conductive pipe is made of metal.

12. The liquid cooling apparatus of claim 11, wherein the conductive pipe is made of copper.

13. The liquid cooling apparatus of claim 11, wherein the conductive pipe is made of aluminum.

14. The liquid cooling apparatus of claim 9, wherein the connecting portion has an external screw thread formed on an outer surface thereof, and the coupling portion of the coupling member has an internal screw thread formed on an inner surface thereof and mated with the external screw thread.

15. The liquid cooling apparatus of claim 9, wherein the connection member has a jutting fastening portion formed at the other end thereof, and the jutting fastening portion is a tube with an external screw thread.

16. The liquid cooling apparatus of claim 9 further having a pump to move the coolant to circulate between the heat absorption unit and the cooling unit.

17. The liquid cooling apparatus of claim 16, wherein the pump is located in the heat absorption unit in an integrated fashion.
